(19) United States
(12) Patent Application Publication
(10) Pub. No.: US 2010/0305927 A1
(43) Pub. Date: Dec. 2, 2010

(54) UPDATING A RESERVOIR MODEL USING ORIENTED CORE MEASUREMENTS

(75) Inventors: Roberto Suarez-Rivera, Salt Lake City, UT (US); William B. Batzer, Newtown, CT (US); Luis Ochoa, Sugar Land, TX (US)

Correspondence Address: Schlumberger Technology Corporation, P. O. Box 425045, Cambridge, MA, 02142, US

(73) Assignee: Schlumberger Technology Corporation, Cambridge, MA (US)

(21) Appl. No.: 12/472,732

(22) Filed: May 27, 2009

(51) Int. Cl. G06G 7/50

(52) U.S. Cl. 703/10

(57) ABSTRACT

A method of updating a model of a subsurface reservoir using a sidewall core obtained from within the reservoir that comprises: making one or more directionally dependent measurements on said sidewall core, determining the in-situ position and orientation of the sidewall core, and updating a reservoir model of the reservoir using the directionally dependent measurements and the in-situ position and orientation of said sidewall core. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### FIELD OF DISCLOSURE

The present application is generally related to the petrophysical and geological study of hydrocarbon bearing wells, and more particularly to methods and apparatus associated with the updating of reservoir models using measurements obtained from downhole cores. These methods and apparatus can, for example, reduce the uncertainties inherent in reservoir models by using these core measurements. The methods and systems that may be used to update a reservoir model using these core measurements will be discussed in the present disclosure by ways of several examples that are meant to illustrate the central idea and not to restrict in any way the disclosure.

### BACKGROUND OF DISCLOSURE

In order to improve the recovery of hydrocarbons from oil and gas wells, a structural study of the reservoir is often done. There are multiple techniques currently in use in the oil industry to evaluate properties of a subsurface geological layer, one such technique comprises the coring of the sidewall of a well. Once the sidewall core has been retrieved, a multitude of laboratory tests can be made to ascertain valuable formation properties like porosity, permeability, clay content, facie, etc. With this sidewall core, also called a plug, the properties measured in the laboratory can be associated with the location within the borehole where the sidewall core was taken. This association may be documented by inputting the core's properties into a description of the reservoir in a reservoir modeling package such as PETREL* or a reservoir flow simulator such as ECLIPSE* (*—marks of Schlumberger). As a subsurface layer is never homogeneous in composition nor in its properties, the study of the total properties of the sidewall core can be taken a step further by analyzing, as an example, the vertical versus horizontal permeability of the plug. This could be achieved in most laboratories in the business of analyzing cores for the oil industry but unfortunately such a study will be meaningless if the in-situ position and orientation of the plug is unknown. The present application demonstrates that by following the methodology herein disclosed, directionally dependent properties measured from the sidewall core in the laboratory can be appropriately translated into subsurface properties therefore yielding a more complete understanding of the reservoir being studied.

A deeper understanding of reservoir characteristics is of great importance to any oil field. Properties such as depositional energy and direction of primary deposition play a key role in economically producing channel type reservoirs. Understanding the direction and magnitude of geomechanical stresses in a tight gas formation is essential for the effective design of a formation fracture operation. There are multiple examples of information that can be extracted from a laboratory study of a sidewall core that a person of ordinary skill in the art will recognize as beneficial to the understanding of a reservoir should it be possible to translate those laboratory result into a three dimensional description of the reservoir.

Information regarding the subsurface is typically acquired using wireline logging tools and/or logging while drilling tools. These tools are often used in the oil industry to study the subsurface geology through which a borehole passes. Examples include electro-magnetic tools (such as the Fullbore Formation MicroImager (FMI*) and Oilbase Micro Imager (OBMI*) wireline logging tools and the PeriScope* and geoVision* logging while drilling tools) and sonic tools (such as the Ultrasonic Borehole Imager (UBI*) and SonicScanner* wireline logging tools and the SonicVision logging while drilling tool) that help define the petrophysical properties of subsurface layer intersected by a wellbore.

Data from some of these tools can be used to generate visual images of the borehole wall. From these images, certain characteristics of the layers can be studied, such as but not limited to: identifying if a fracture is open or closed, secondary porosity, stratigraphic and structural dipping, etc. These imaging tools typically combine the information of the imaging part of the tool with a set of accelerometers and magnetometers so every feature in the image can be located spatially within the borehole via a processing computer. Measurement while drilling tools and/or downhole surveying tools can also be used to determine a well's trajectory (the spatial locations a well passes through from the surface location where the well begins to the point within the subsurface at which the well ends). From such a trajectory and by knowing how far within the well the wireline tool or measurement while drilling tool is when the measurement is obtained (i.e. the apparent depth), it is possible to locate in space where the measurement was obtained and the spatial orientation of the wellbore at that point.

Hydrocarbon wells are often logged with wireline and/or logging while drilling tools and this information may be used to study the petrophysical and geological properties of the reservoir. With respect to the sidewall core, a multitude of physical parameters of the rock sample may be determined in a core laboratory such as but not limited to porosity, permeability, density, natural gamma-ray radiation amongst others.

The logging measurements can be located spatially with the help of accelerometers and magnetometers located in the logging tool and/or the well trajectory information as discussed above. With this information the precise orientation, azimuth and cardinal coordinates of these measurements is known.

The in-situ orientation of the core can be determined using one or more of a variety of techniques that are discussed below. A borehole image and a digital image of the borehole face of the sidewall core can be used, for instance, to determine the proper in-situ orientation of the core by rotating the core image until an appropriate fit is found. With this orientation information and the laboratory results, as way of example but not to limit this disclosure, such as anisotropy magnitude and direction of stresses or difference in permeability within the core depending of the direction of the flow, a model of the reservoir can be updated to more accurately reflect downhole conditions.

### SUMMARY OF THE DISCLOSURE

The following embodiments provide examples and do not restrict the breath of the disclosure and will describe ways to use laboratory data regarding a core to update a reservoir model of the formation from which the core was taken. Once, for instance, core and borehole images are matched by a processing unit then information regarding the orientation, azimuth and coordinates recorded during the borehole imaging log can by associated with the core and the reservoir model may be updated.

The embodiments described herein can be described as a method of updating a model of a subsurface reservoir using a sidewall core obtained from within the reservoir that comprises: making one or more directionally dependent measurements on said sidewall core, determining the in-situ position and orientation of the sidewall core, and updating a reservoir model of the reservoir using the directionally dependent measurements and the in-situ position and orientation of said sidewall core.

In certain embodiments, determining the in-situ orientation of the sidewall core includes recording an image of the borehole wall over the interval were a reservoir core has been or will be taken, creating an image of the wellbore end of the reservoir core and using software to determine the apparent orientation of the sidewall core with respect to the wellbore wall. The wellbore image may be recorded by a wireline or logging while drilling tool that scans (at least partially) the circumference of the borehole wall in an interval and records the location of the resulting image with respect to the borehole. The method may utilize measurements of either or both the core and the borehole generated by an ultrasonic, micro-resistivity, micro-sonic, or inductive apparatus or downhole or uphole cameras. Recording of the image of the borehole may be done before or after the sidewall core is taken. The laboratory results from analyzing the core are combined with the core's in-situ spatial orientation and used to develop or update a model of the reservoir being studied.

Further features and advantages of the invention will become more readily apparent from the following detailed description when taken in conjunction with the accompanying drawings.

### BRIEF DESCRIPTION OF THE DRAWINGS

FIG. 1 is a flowchart showing various processes associated with embodiments of the described method.

FIG. 2 shows an image of a borehole logged with an imaging tool in both 3D and 2D.

FIG. 3 shows a theoretical example of a thrust fault or fracture plane.

FIG. 4 shows a core in-situ orientation example.

### DETAIL DESCRIPTION

In the following detailed description of preferred embodiments, reference is made to accompanying drawings, which form a part hereof, and within which are shown by way of illustration specific embodiments by which the invention may be practiced. It is to be understood that other embodiments may be utilized and structural changes may be made without departing from the scope of the invention.

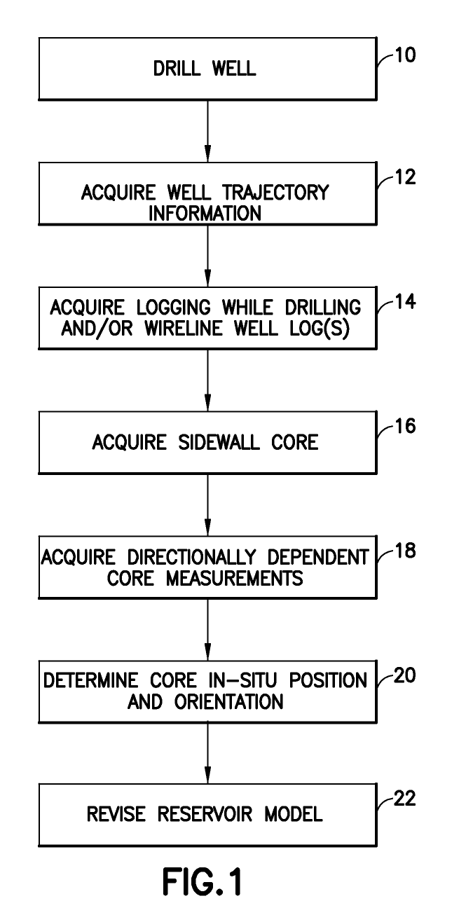

FIG. 1 shows a flow chart with processes associated with embodiments of the described method. Drill Well Process 10 is followed by Acquire Well Trajectory Information 12, Acquire Logging While Drilling and/or Wireline Well Log(s) 14, and Acquire Sidewall Core 16. Laboratory analysis on the sidewall core is then performed in Make Directionally Dependent Core Measurements 18. The position and orientation of the core downhole before it was removed from the borehole was is estimated in Determine Core In-Situ Position and Orientation 20. The core measurements and core position and orientation information is then used to update the reservoir model in Revise Reservoir Model 22. “Updating” the reservoir model can alternatively be thought of as “developing” a new reservoir model or “revising” or “modifying” an existing reservoir model and for the purposes of this applications and the following claims, the term “developing” includes all such uses of the core measurement and core position and orientation information.

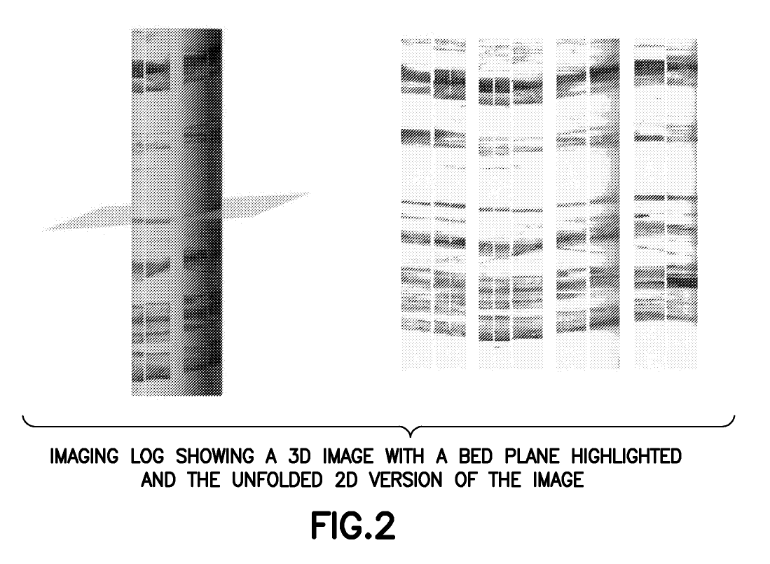

FIG. 2 shows an image of a borehole logged with a wireline tool in both its 3D representation and its 2D, “flat” or unfolded form. If this type of well log is acquired after the sidewall core has been removed from the borehole wall, it is often possible to identify the precise location where the sidewall core has been acquired.

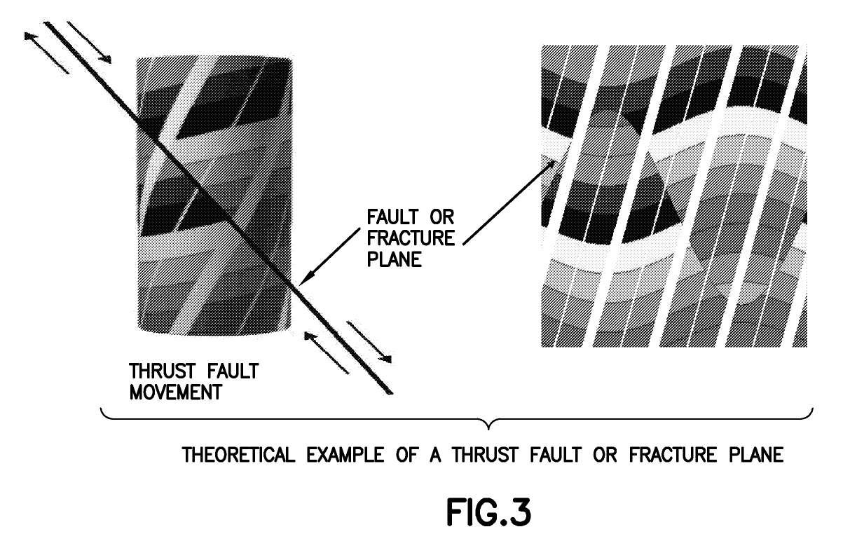

FIG. 3 shows a theoretical example of the possible complexities found in a reservoir; in this case a “thrust fault” or a fracture plane with a displacement of the fracture planes relative to each other. FIG. 3 illustrates the fact that a core taken in one side of the wall may differ widely from a core taken at the same depth but on the other side of the wall. Typical sidewall core tools do not discriminate which side of the borehole the core will be taken, depending on the design of the tool the sidewall core might be taken on the low or high side of the borehole. This theoretical representation of a possible downhole environment aims to illustrate the importance of locating a core spatially within the reservoir model. A person skilled in the art will appreciate the fact that decisions solely taken from the results of the analysis of a core taken at a determinate depth within the reservoir might be erroneous if such core is not appropriately spatially located within said reservoir. In the theoretical example in FIG. 3, a sidewall core taken in one side of the borehole might show a high shale content and therefore low likelihood of commercial production but a sidewall core taken on the other side of the borehole might show high porosity sandstone and therefore a better change of economically successfully producing the reservoir at this location. Similarly this analysis can be carried out on more complex studies of the reservoir, such as but not limited to stress anisotropy, tri-axial permeability differences, rock texture, sedimentation energy and direction, just to name a few.

Addition core orientation information can be obtained by measuring the orientation of the sidewall coring tool as the core is being taken using a sensor such as a gyroscope (such as a rate gyroscope), an inclinometer, a tiltmeter, or a gravimeter.

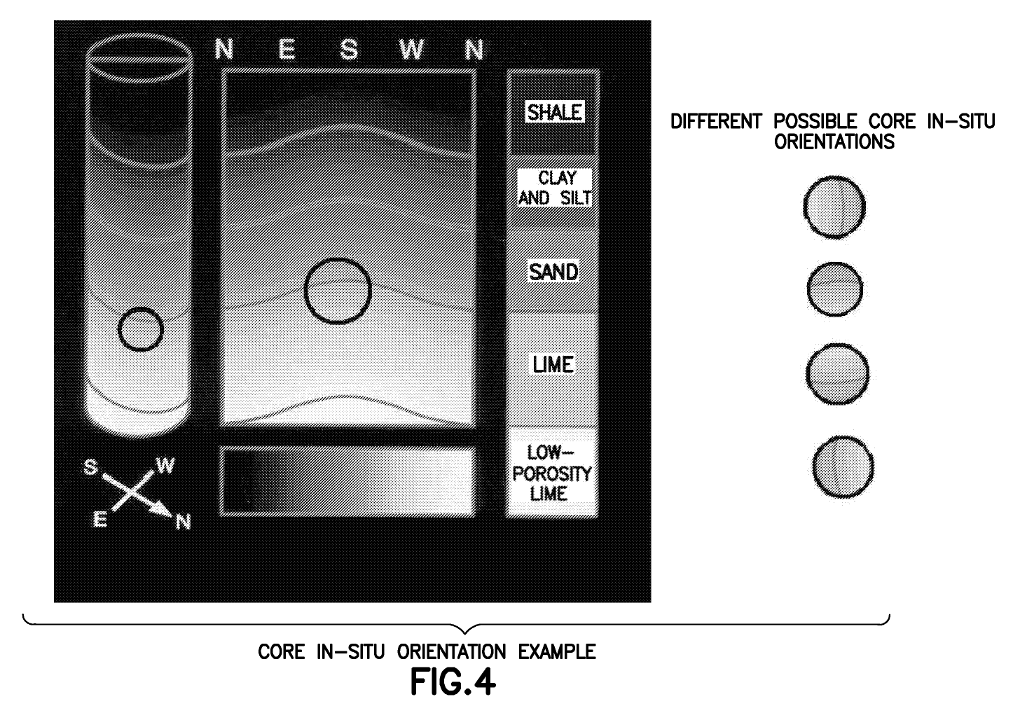

FIG. 4 shows an example of how a core taken from a wellbore will be more representative if the orientation of said core is known and laboratory results can be appropriately translated into the reservoir model. Most laboratories have the capability to perform tests on cores by measuring its properties in different directions. If these measurements can be paired with the spatial information of the core; and if the core can be located spatial in the wellbore it was taken from, then the reservoir models can be more accurately defined.

To illustrate the challenges faced while studying a reservoir core, a sidewall core taken from a wellbore in a reservoir layer will have a measured property that will differ from the same measurement done on the same formation layer from a full bore core just because the laboratory will measure the parameters of the cores in different directions considerably adding unknowns to the reservoir model. Analogically, a sidewall core taken from a wellbore that is intersecting a reservoir layer perpendicularly will have a measured property that will differ from the same measurement done on the same formation layer from a sidewall core if the wellbore intersects the reservoir layer at a high angle.

If the laboratory analyzing the cores pairs the measured properties resulting of the analysis of said core to directional data, and perform said analysis in multiple directions, all these information can then be fed into the reservoir model accurately by using the method herein disclosed.

As measured properties of cores can impact the economic model of a field, most clients will use such a model to decide if the field is economical to produce or not. Using the techniques described above, it is possible to determine the location at which the sidewall core was obtained. Using either the image logs and trajectory information or information (or assumptions) regarding the orientation of the sidewall tool as the core is being obtained, it is possible to determine the in-situ orientation of the sidewall core cylinder before removal from the borehole wall. Because of the way sidewall cores are obtained and stored within the tool, it is typically easy to determine which end is the borehole end of the core. It is also often possible to confirm which end is the borehole end of the core because it has a curved surface associated with the curvature of the borehole wall face at the point where the core was removed. What is typically the most difficult is to determine how the core should be rotated to be in its proper in-situ orientation, as shown above in FIG. 4.

Some methods for determining the in-situ orientation of sidewall cores are described in SPE 56801, “Oriented Drill Sidewall Cores For Natural Fracture Evaluation”, by S. E. Laubach and E. Doherty, which is incorporated herein by reference. Additional methods are described in “A simple method for orienting drill core by correlating features in whole-core scans and oriented borehole-wall imagery”, by T. S. Paulsen, et al., in the Journal of Structural Geology 24 (2002) 1233-1238, also incorporated herein by reference. It is also possible to image the borehole (i.e. wellbore) end of the core in the laboratory using ultrasonic, micro-resistivity, micro-sonic, or inductive apparatus or cameras and determine the proper orientation of the core with respect to the borehole, such as by using computerized image registration techniques such as those described in “Image registration methods: a survey” by B. Zitova and J. Flusser in Image and Vision Computing 21 (2003) pp. 977-1000, incorporated herein by reference.

Typically the granularity of an image obtained from the borehole end of the core in the laboratory will be much finer than the granularity of the image obtained from the wellbore wall. Schlumberger's Fullbore Formation MicroImager wireline logging tool, for instance, produces an image of the borehole wall with a vertical and azimuthal resolution of 0.2 inches (0.51 cm). An image of the borehole end of the core obtained in a laboratory will typically have pixels that are much smaller, from half as large in each direction to one tenth as large or even smaller in each direction.

In an alternate preferred embodiment, a core can be tested in a laboratory for properties (such as permeability) parallel and perpendicular to said layering and the results can then be oriented and used to update the reservoir model. This method can prove to be particularly important in thin layer reservoir types where the hydrocarbon will mainly flow in channels parallel to the layering of said reservoir but will not flow perpendicularly to said layers. This type of embodiment may be particularly important when the core has significant layering, such as where the layers of formations are visible with the naked eye.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. Further, like reference numbers and designations in the various drawings indicated like elements.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope of the appended claims.

1. A method of updating a model of a subsurface reservoir using a sidewall core from within the reservoir comprising:
i. making one or more directionally dependent measurements on said sidewall core,
ii. determining the in-situ position and orientation of said sidewall core, and
iii. updating a model of the reservoir using said directionally dependent measurements and said in-situ position and orientation of said sidewall core.

2. A method as in claim 1, wherein said in-situ orientation of said sidewall core is determined, in part, using a borehole wall image.

3. A method as claimed in claim 2, wherein said borehole wall image is recorded by an apparatus that scans at least partially the circumference of the borehole wall along a determinate interval and records the location of the resulting image with respect to said borehole.

4. A method as in claim 2, wherein the image of the borehole wall is generated by one or more of an ultrasonic apparatus, a micro-resistivity apparatus, a microsonic apparatus, a downhole camera and an inductive apparatus.

5. A method as in claim 2, wherein the image of the borehole wall has a granularity larger than the granularity of the image of the sidewall face of the reservoir core.

6. A method as in claim 1, wherein determining the in-situ position of said sidewall core includes obtaining wellbore trajectory information.

7. A method as in claim 1, wherein determining the in-situ orientation of said sidewall core includes acquiring orientation information regarding a sidewall coring tool as said sidewall coring tool is acquiring said sidewall core.

8. A method as in claim 1, wherein said core shows significant layering.

9. A method as in claim 8, wherein making one or more directionally dependent measurements on said sidewall core comprises making one or more directionally dependent measurements perpendicular and parallel to said significant layering,

10. A method for using directionally dependent laboratory core analysis result information to update a reservoir model comprising:
i. assigning a position and orientation to said directionally dependent laboratory core analysis information; and
ii. utilizing said position, orientation, and directionally dependent laboratory core result information to update said reservoir model.

11. A method as in claim 10, wherein said directionally dependent laboratory core analysis information comprises measurements made perpendicular and parallel to layering observed on a sidewall core.
